(19) United States
(12) Patent Application Publication
(10) Pub. No.: US 2019/0318229 A1
(43) Pub. Date: Oct. 17, 2019

(54) METHOD AND SYSTEM FOR HARDWARE MAPPING INFERENCE PIPELINES

(71) Applicant: Advanced Micro Devices, Inc., Santa Clara, CA (US)

(72) Inventor: Shuai Che, Bellevue, WA (US)

(73) Assignee: Advanced Micro Devices, Inc., Santa Clara, CA (US)

(21) Appl. No.: 15/952,131

(22) Filed: Apr. 12, 2018

(51) Int. Cl. G06N 3/063; G06N 3/04

(52) U.S. Cl. CPC G06N 3/063; G06N 3/04

(57) ABSTRACT

Methods and systems for hardware mapping inference pipelines in deep neural network (DNN) systems. Each layer of the inference pipeline is mapped to a queue, which in turn is associated with one or more processing elements. Each queue has multiple elements, where an element represents the task to be completed for a given input. Each input is associated with a queue packet which identifies, for example, a type of DNN layer, which DNN layer to use, a next DNN layer to use and a data pointer. A queue packet is written into the element of a queue, and the processing elements read the element and process the input based on the information in the queue packet. The processing element then writes another queue packet to another queue based on the processed queue packet. Multiple inputs can be processed in parallel and on-the-fly using the queues independent of layer starting points.

### BACKGROUND

Deep neural networks (DNNs) are used for many artificial intelligence and machine learning applications. These DNNs nominally include multiple hidden layers between an input layer and an output layer. Recently, DNNs have started to use an increasing number of layers which provide increased capacity and accuracy for various prediction problems in image, video, and speech recognition processing and analysis. However, deeper DNNs also result in increasingly greater performance challenges.

For example, today's software systems and application programming interfaces (APIs), such as Keras, Caffe, and Tensorflow® (trademark of Google LLC), are designed where users call a predict() or similar function for each individual input or batch of inputs of interest (e.g., an image) during an inference phase of the DNN, where the inference phase being when logical rules are applied to the inputs to deduce outputs. In particular, the predict() call generates a prediction result for the application to use. In some systems (e.g., Caffe), this predict() call is synchronous for each input or batch of inputs. That is, the next input has to wait for the current input going through the entire DNN pipeline before execution of the next input. The inference performance is important for quality of service (QoS) in many real world applications. The deeper the DNN, the more problematic conventional approaches become.

### BRIEF DESCRIPTION OF THE DRAWINGS

A more detailed understanding may be had from the following description, given by way of example in conjunction with the accompanying drawings wherein:

FIG. 1 is a block diagram of an example device in accordance with certain implementations;

FIG. 2 is a block diagram of the device of FIG. 1 in accordance with certain implementations;

FIG. 3 is a block diagram of an Heterogeneous System Architecture (HSA) platform in accordance with certain implementations;

FIG. 4 is a block diagram of an example system illustrating queue structures in accordance with certain implementations;

FIG. 5A is an example block diagram of command packet processing in accordance with certain implementations;

FIG. 5B shows an example element that includes command packets and an indirect buffer (IB) command packet in accordance with certain implementations;

FIG. 5C is an example indirect buffer in accordance with certain implementations;

FIG. 6 is a block diagram of a system which illustrates mapping of an inference pipeline to HSA-enabled type architecture in accordance with certain implementations; and

FIG. 7 depicts an illustrative system using different DNN networks in accordance with certain implementations.

### DETAILED DESCRIPTION

Described herein is a method and system for hardware mapping inference pipelines in deep neural network (DNN) systems to improve inference latency and throughput. An inference pipeline consists of a plurality of DNN layers including, but not limited to, a convolution layer, a fully connected layer, an activation layer, a pooling layer, a dropout layer, a batch normalization layer and the like. Each layer of the inference pipeline is mapped to a queue, which in turn is associated with one or more processing elements. Each queue has multiple elements, where an element represents the task to be completed for a given input. Each input is associated with a queue packet which identifies, for example, the type of DNN layer, which DNN layer to use, next DNN layer to use and a data pointer (collectively a DNN processing profile). A queue packet is written into an element of a queue, and the processing elements read the element and process the input associated with the queue packet. The processing element then pushes or writes a new queue packet to another queue based on the processed queue packet. Consequently, multiple inputs are processed in parallel and on-the-fly using the queues independent of layer starting points.

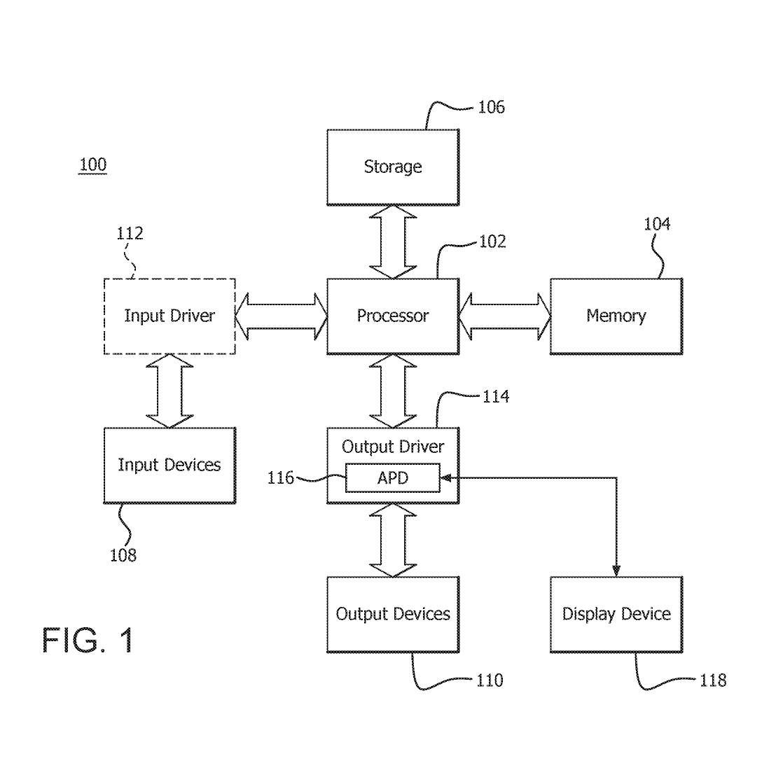

FIG. 1 is a block diagram of an example device 100 in which one or more features of the disclosure can be implemented. The device 100 includes, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 also optionally includes an input driver 112 and an output driver 114. It is understood that the device 100 includes additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide (graphical) output to a display device 118. For example, it is contemplated that any processing system that performs processing tasks in accordance with a SIMD paradigm can be configured to perform the functionality described herein. Alternatively, it is contemplated that computing systems that do not perform processing tasks in accordance with a SIMD paradigm performs the functionality described herein.

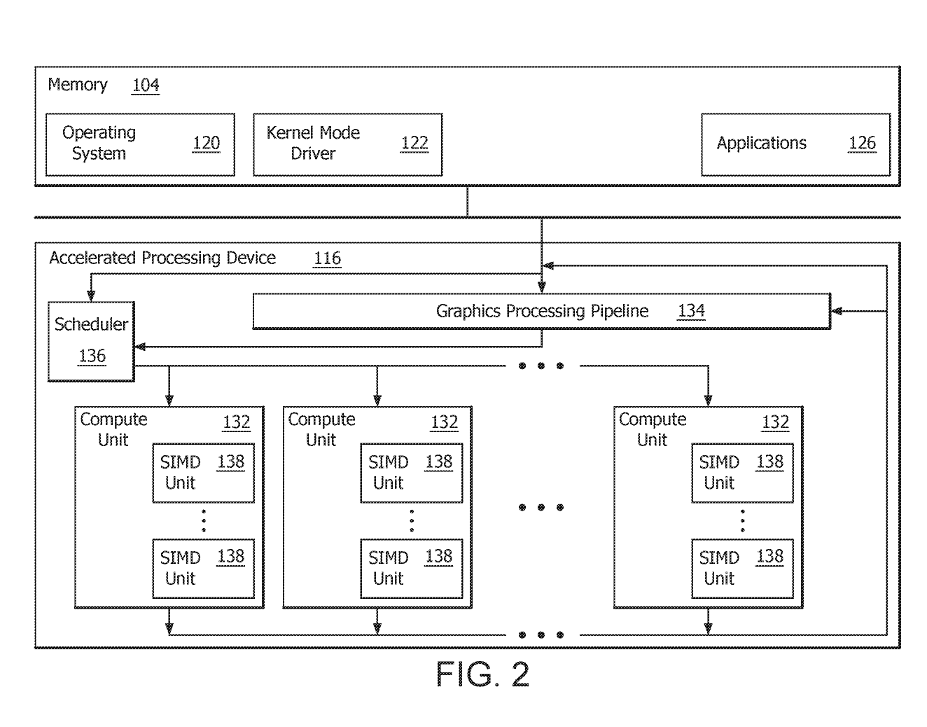

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further details below) of the APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 can have a local L1 cache. In an implementation, multiple compute units 132 share a L2 cache.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group is executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

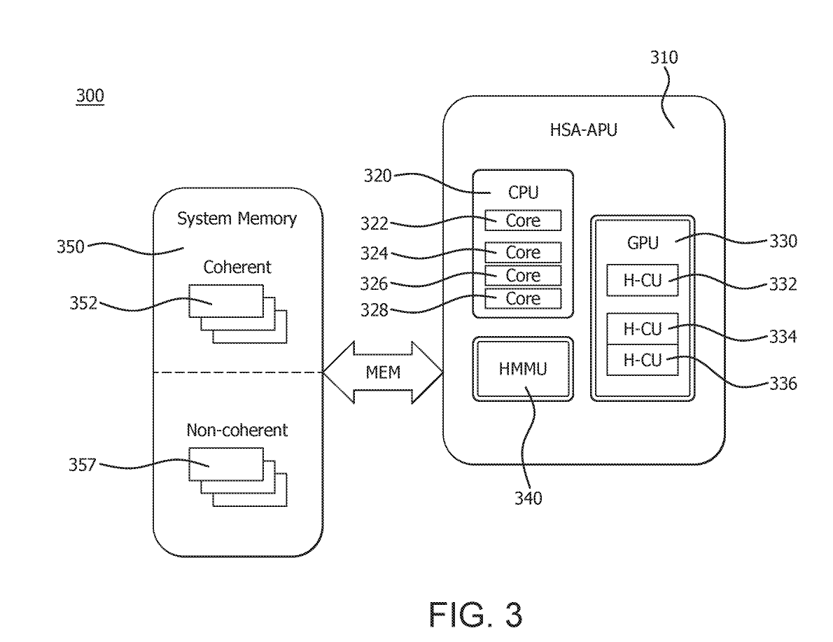

FIG. 3 illustrates a Heterogeneous System Architecture (HSA) platform 300 based in part on the devices of FIGS. 1 and 2. The HSA platform 300 includes a HSA Accelerated Processing Unit (APU) 310 connected to or in communication with (collectively “connected to”) a system memory 350. The HSA APU 310 contains a multi-core CPU 320, a GPU 330 with multiple HSA compute units (H-CUs) 332, 334, 336, and a HSA memory management unit (HMMU or HSA MMU) 340. The CPU 320 includes any number of cores, with cores 322, 324, 326, 328 shown in FIG. 3. The GPU 330 includes any number of H-CUs although three are shown in FIG. 3. While a HSA is specifically discussed and presented in the described implementations, the present system and method can be utilized on either a homogenous or heterogeneous system. The system memory 350 includes one or both of coherent system memory 352 and non-coherent system memory 357.

The HSA 300 provides a unified view of fundamental computing elements. The HSA 300 allows a programmer to write applications that seamlessly integrate CPUs 320, also referred to as latency compute units, with GPUs 330, also referred to as throughput compute units, while benefiting from the best attributes of each. The HSA 300 allows the programmer to take advantage of the parallel processor in the GPU 330 as a peer to the traditional multi-threaded CPU 320. A peer device is defined as an HSA device that shares the same memory coherency domain as another device.

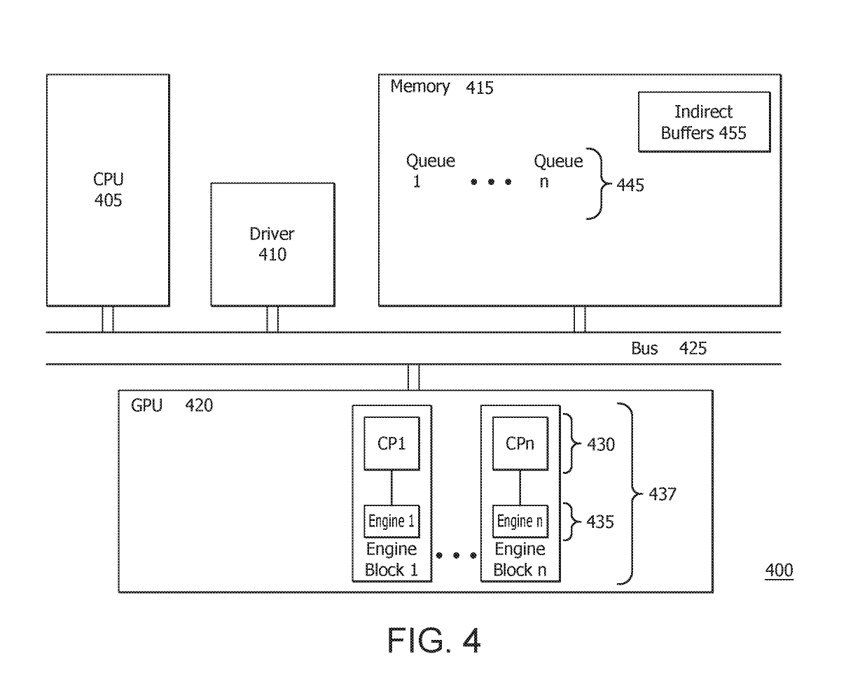

The devices in the HSA 300 communicate with one another using queues as further explained with reference to FIGS. 4-6. Queues are an integral part of the HSA architecture. A queue is a physical memory area where a producer places a request for a consumer. Depending on the complexity of the HSA hardware, queues might be managed by any combination of software or hardware. Hardware managed queues have a significant performance advantage in the sense that an application running on latency processors (such as CPU 320) queues work to throughput processors (such as GPU 330) directly, without the need for any intervening operating system calls. This allows for very low latency communication between the devices in the HSA 300.

FIG. 4 is a block diagram of an example system 400 illustrating queue structures. The system 400 includes a CPU 405, a system memory 415, a driver 410, a graphics processing unit (GPU) 420, and a communication infrastructure or bus 425. A person of skill in the art will appreciate that system 400 includes software, hardware, and firmware components in addition to, or different from, that shown in FIG. 4. It is understood that the system 400 includes additional components not shown in FIG. 4.

The CPU 405, GPU 420 and system memory 415 can be implemented as described with respect to FIGS. 1-3. The CPU 405 executes an operating system (not shown) and one or more applications, and is the control processor for system 400. The operating system executing on CPU 405 controls, facilitates access and coordinates the accomplishment of tasks with respect to system 400. The driver 410 (e.g., a graphics driver) includes software, firmware, hardware, or any combination thereof. In an implementation, the driver 410 is implemented entirely in software. The driver 410 provides an interface and/or application programming interface (API) for the CPU 405 and applications executing on the CPU 405 to access the GPU 420. The bus 425 provides coupling between the components of system 400 and includes one or more communication buses such as Peripheral Component Interconnect (PCI), Advanced Graphics Port (AGP), and the like.

The GPU 420 provides graphics acceleration functionality and other compute functionality as described herein to system 400. The GPU 420 includes multiple command processors (CP) CP 1 . . . CP n 430, and multiple engines Engine 1 . . . Engine n 435, for example, 3D engines, unified video decoder (UVD) engines, digital rights management (DRM) direct memory access (DMA) engines and the like.

The CP 1 . . . CP n 430 controls the processing within GPU 420 and is connected to Engine 1. . . Engine n 435. Each CP 1 . . . CP n 430 is associated with Engine 1 . . .Engine n 435 and each pair is an engine block (EB) EB 1 . . . EB n 437. In another embodiment, the CP 1 . . . CP n 430 is a single command processor. In general, the CP 1 . . . CP n 430 receives instructions to be executed from the CPU 405, and coordinate the execution of those instructions on Engine 1 . . . Engine n 435 in GPU 420. In some instances, the CP 1 . . . CP n 430 generates one or more commands to be executed in GPU 420, that correspond to each command received from CPU 405. Logic instructions implementing the functionality of the CP 1 . . . CP n 430 is implemented in hardware, firmware, or software, or a combination thereof.

The memory 415 includes a one or more memory devices and can be a dynamic random access memory (DRAM) or a similar memory device used for non-persistent storage of data. Memory 415 includes one or more memory buffers 445 through which CPU 405 communicates commands to GPU 420. The memory buffers 445 correspond to the engines 435 or the engine blocks 437, as appropriate. Memory buffers 445 are implemented as queues, ring buffers or other data structures suitable for efficient queuing of work items or command packets. In the instance of a queue, command packets are placed into and taken away from the memory buffers 445 in a circular manner. For purposes of illustration, memory buffers 445 are referred to as queue 1 . . . queue n 445 herein.

The memory 415 includes indirect buffers 455. The indirect buffers 455 hold the actual commands (e.g., instructions, data, pointers and non-pointers). For example, when the CPU 405 communicates a command packet to the GPU 420, the command packet is stored in the indirect buffer 455 and a pointer to that indirect buffer 455 is inserted in a queue 1 . . . queue n 445. As described herein below, certain of the indirect buffers 455 hold neuron data. That is, multiple indirect buffers are used for different purposes. The CPU 405, via driver 410, as a writer of the commands to queue 1 . . . queue n 445 and the GPU 420 as a reader of such commands, coordinate a write pointer and read pointer indicating the last item added and last item read, respectively, in queue 1 . . . queue n 445.

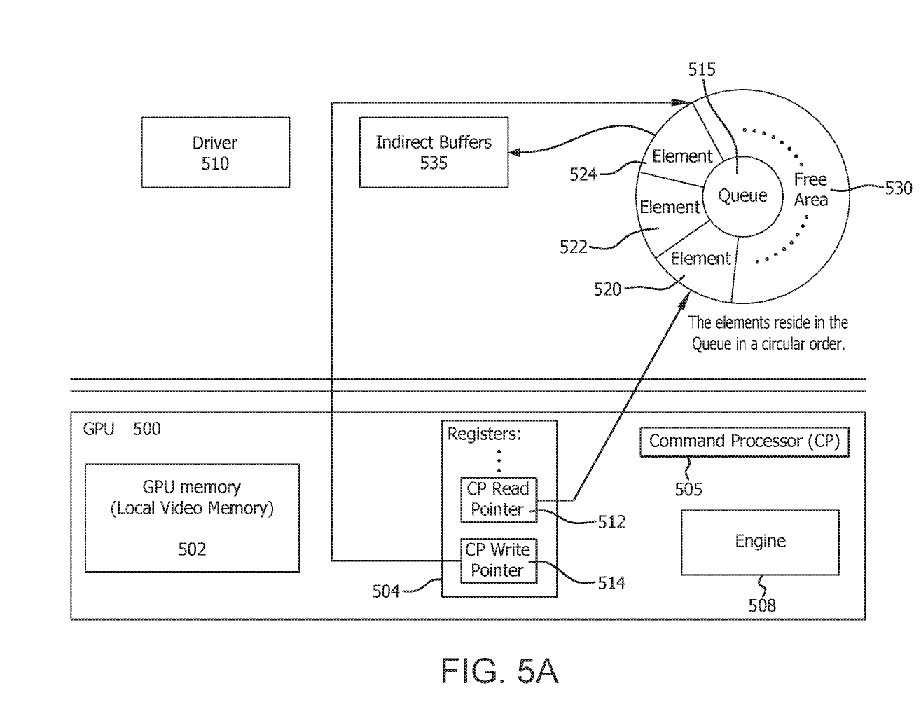

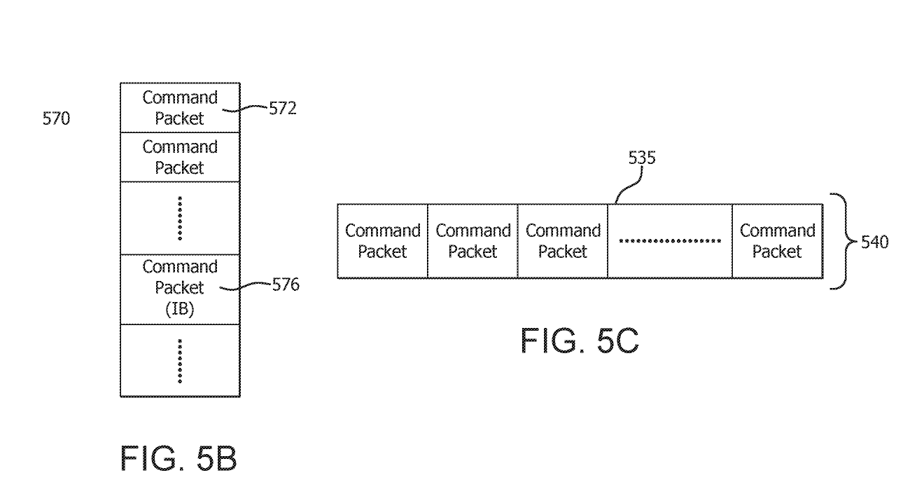

FIG. 5A is an example block diagram of command packet processing as between a GPU 500, a driver 510, a queue 515 and indirect buffer 535. The GPU 500 includes a GPU memory 502, registers 504, a command processor 505, and an engine 508. The registers 504 include a read pointer 512 and a write pointer 514. The queue 515 includes elements 520, 522, 524 and free space 530. Each element, for example, elements 520, 522, 524 store queue packets. FIG. 5B shows an example element 570 that includes command packets 572 and an indirect buffer (IB) command packet 576 which points to the indirect buffer 535. The indirect buffer 535, as shown in FIG. 5C, includes command packets 540 which instruct the GPU 500 to carry out operations. For example, a kernel dispatch packet (an example of the command packet 540) in HSA includes information such as how the computation kernel should launch threads (grid dimension, workgroup size), required size of private and group memory allocations, handle for an object in memory that includes an executable ISA image for the computation kernel, and additional control and synchronization information. In general, the computation kernels, in DNN, are usually convolution, matrix multiply, fast Fourier transform (FFT), pooling, and activations which are implemented by high-level libraries such as for example MIOpen and rocBLAS.

The above architecture provides a one-way communication from a host processor (the writer as represented by the driver 510) to the GPU 500 (the reader as represented by the command processor 505). Initially the read pointer 512 and the write pointer 514 point to the same location indicating that the queue 515 is empty. The queue 515 has free space 530 into which the driver 510 writes a command packet corresponding to a task. The driver 510 then updates the write pointer 514 to one position past the last command packet or the first available space. The write pointer 514 and read pointer 512 are now pointing to different locations. The command processor 505 fetches command packets at the read pointer 512 position and walks the read pointer 512 until it is equal to the write pointer 514.

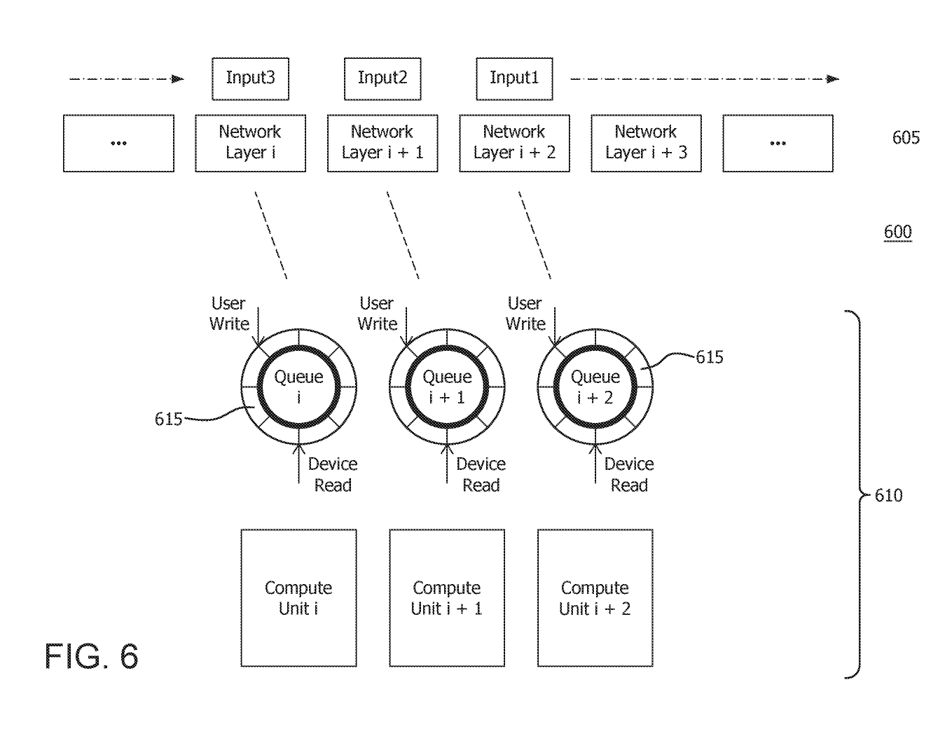

FIG. 6 is a block diagram of a system 600 which illustrates mapping of an inference pipeline 605 to HSA-enabled type architecture 610. The inference pipeline 605 has multiple DNN network layers including network layer i, network layer i+1, network layer i+2, network layer i+3, and so on. Each of the network layer i, network layer i+1, network layer i+2, network layer i+3, and so on can represent different DNN network layer types including, but not limited to, a convolutional network layer, an activation network layer and a fully connected network layer. In accordance with the descriptions herein, the HSA-enabled type architecture 610 has multiple queues including queue i, queue i+1, queue i+2, and so on which are connected to an associated compute unit i, compute unit i+1, compute unit i+2, and so on. Each queue i, queue i+1, queue i+2, and so on includes multiple elements 615, where each element 615 represents the task to be executed for a particular input, e.g. Input1, Input2 and Input3, or a mini-batch for inference processing.

In accordance with an implementation, each of the DNN network layers network layer i, network layer i+1, network layer i+2, network layer i+3, and so on is mapped to a corresponding one of queue i, queue i+1, queue i+2, and so on. The system 600 allows multiple inputs, such as Input1, Input2 and Input3, to be processed on-the-fly in a pipelined manner with efficient mapping to hardware. This mapping is applicable to the inference pipeline 605 as inference processing is a forward pass without backpropagation process. In other words, when Input1 is at DNN network layer i+2, Input2 can be at DNN network layer i+1, Input3 can be at DNN network layer i and so on. The runtime systems maintain and keep track of the dependencies. The DNN architecture shown is illustrative and other architectures are also applicable.

Operationally, a user or user device writes into designated queues and a compute unit command processor (e.g., compute unit i, compute unit i+1, compute unit i+2) reads an element 615 from an associated queue (e.g., queue i, queue i+1, queue i+2) to obtain a task or request. The compute unit performs the task for that DNN network layer (e.g., convolution, activation, etc.) and then pushes a new queue packet (also known or referred to as command packets) to another queue associated with a next DNN layer.

The queue packets associated with the tasks are augmented to include information to optimize DNN processing. In an implementation, the command packet includes, but is not limited to, DNN network identifier, layer identifier, pointer to indirect buffer for data such as neuron data, and previous/next layer identifiers.

The layer identifier specifies the type of DNN layer, e.g. a convolution layer, activation layer, pooling layer, etc. The system 600 uses this information to determine what computation to do and what kernels to launch for the current layer. The DNN network identifier enables processing of multiple DNN workloads by designating which network to use, such as for example, Alexnet, Googlenet, Resnet, or user's model/network.

The previous/next layer identifiers identify the network layers to which the current layer connects. These identifiers can be lists if the current layer connects to multiple layers. The next layer identifier is useful in determining into which queue a queue packet should be pushed (for the next layer) after completing the computation for the current layer.

The pointer to the data buffer (also known as a neuron buffer) points to the data that is used as input for processing the current layer. For example, the neurons buffer is implemented as an indirect buffer. Different types of data buffer structures are used depending on the type of layer. For example, feature maps are used for convolution layers, vectors are used for fully connected layers, etc.

In an implementation, the processing engine associated with a queue is treated as a “server” to process a specific layer type in the entire pipeline. Multiple processing engines are associated with the same queue (layer type) to improve parallelism.

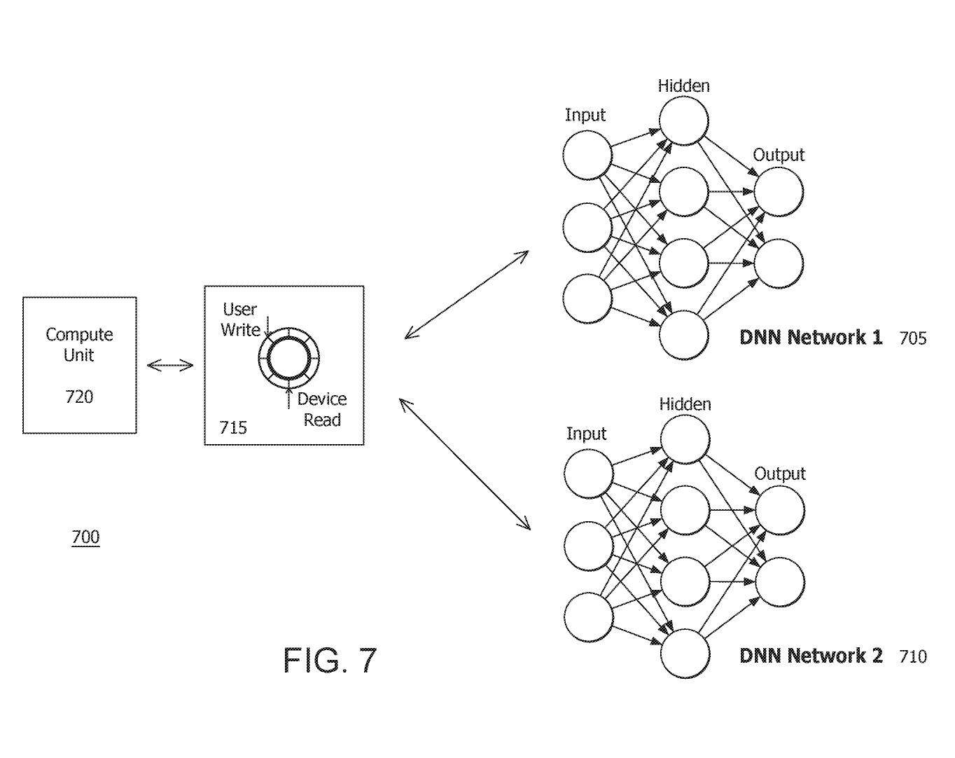

In another implementation, different users submit requests which use different DNN networks. The different DNN networks can have different architectures but share the same type of layer. In this case, a compute unit and queue processes requests from multiple users for that layer. The DNN network identifier is used for this differentiation. FIG. 7 depicts an illustrative system 700 using different DNN networks in accordance with certain implementations. The system 700 includes for example a DNN network 1 705 and a DNN network 2 710, which are each connected to a compute unit 720 via a queue 715. In this scenario, different users use DNN network 1 705 and DNN network 2 710 but the DNN computations, operations or inputs are sent to the same compute unit, for example, the compute unit 720 via the queue 715 by using different DNN network identifiers.

In an implementation, the queuing architecture is extendable to a distributed system where another machine (or a portion thereof) or multiple machines is a “server” to process a particular layer type. Queue packets are pushed to the queues on the other machines through remote direct memory access (RDMA) or network interface card (NIC) capabilities.

In general, a deep neural network (DNN) system includes a plurality of queues and a plurality of processing elements. Each queue of the plurality of queues is associated with at least one of the plurality of processing elements. The system also includes an inference pipeline including a plurality of DNN layers, where each queue of the plurality of queues is mapped to one of the plurality of DNN layers. The system processes multiple inputs in parallel by the plurality of queues and the plurality of processing elements, each queue and associated processing element being configured to process an input based on a DNN processing profile determined from a queue packet associated with the input. In an implementation, the queue packet identifies at least a DNN network identifier, a DNN layer identifier, a pointer to buffer for data, and previous/next DNN layer identifiers. In an implementation, the DNN layer identifier identifies a DNN layer type, which is used to determine a nature of computation to be performed and what kernels to launch. In an implementation, the DNN network identifier enables processing of multiple DNN workloads by designating which network to use. In an implementation, the previous/next DNN layer identifiers identify connected DNN layers. In an implementation, the queue packets include at least instructions on how to launch threads, provide a size of private memory allocation, provide a size of group memory allocation, provide a handle for an object in memory that includes an executable ISA image for a computation kernel, and control and synchronization information. In an implementation, certain of the plurality of queues and associated processing elements receive queue packets through remote direct memory access. In an implementation, the plurality of DNN layers is different DNN layer types. In an implementation, each of the multiple inputs is processed at a different DNN layer type. In an implementation, an associated processing element for a queue processes with respect to a specific DNN layer. In an implementation, the specific DNN layer is supported by different DNN networks to enable multiple use of the specific DNN layer.

In general, a method for deep neural network (DNN) processing includes processing in parallel for multiple inputs, writing a queue packet associated with each input to a queue, where each queue is mapped to one of a plurality of DNN layers in an inference pipeline and processing, by a processing element associated with each queue, the input based on a DNN processing profile determined from the queue packet. In an implementation, the queue packet identifies at least a DNN network identifier, a DNN layer identifier, a pointer to buffer for data, and previous/next DNN layer identifiers. In an implementation, the DNN layer identifier identifies a DNN layer type, which is used to determine a nature of computation to be performed and what kernels to launch. In an implementation, the DNN network identifier enables processing of multiple DNN workloads by designating which network to use. In an implementation, the previous/next DNN layer identifiers identify connected DNN layers. In an implementation, the queue packets include at least instructions on how to launch threads, provide a size of private memory allocation, provide a size of group memory allocation, provide a handle for an object in memory that includes an executable ISA image for a computation kernel, and control and synchronization information. In an implementation, the method further includes writing another queue packet to another queue based on the processed queue packet. In an implementation, the plurality of DNN layers is different DNN layer types. In an implementation, each of the multiple inputs is processed at a different DNN layer type. In an implementation, an associated processing element for a queue processes with respect to a specific DNN layer. In an implementation, the specific DNN layer is supported by different DNN networks to enable multiple use of the specific DNN layer.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A deep neural network (DNN) system, comprising:
a plurality of queues;
a plurality of processing elements, wherein each queue of the plurality of queues is associated with at least one of the plurality of processing elements; and
an inference pipeline including a plurality of DNN layers, wherein each queue of the plurality of queues is mapped to one of the plurality of DNN layers,
wherein multiple inputs are processed in parallel by the plurality of queues and the plurality of processing elements, each queue and associated processing element being configured to process an input based on a DNN processing profile determined from a queue packet associated with the input.

2. The DNN system of claim 1, wherein the queue packet identifies at least a DNN network identifier, a DNN layer identifier, a pointer to buffer for data, and previous/next DNN layer identifiers.

3. The DNN system of claim 2, wherein the DNN layer identifier identifies a DNN layer type, which is used to determine a nature of computation to be performed and what kernels to launch.

4. The DNN system of claim 2, wherein the DNN network identifier enables processing of multiple DNN workloads by designating which network to use.

5. The DNN system of claim 2, wherein the previous/next DNN layer identifiers identify connected DNN layers.

6. The DNN system of claim 2, wherein the queue packets include at least instructions on how to launch threads, provide a size of private memory allocation, provide a size of group memory allocation, provide a handle for an object in memory that includes an executable ISA image for a computation kernel, and control and synchronization information.

7. The DNN system of claim 1, wherein certain of the plurality of queues and associated processing elements receive queue packets through remote direct memory access.

8. The DNN system of claim 1, wherein the plurality of DNN layers are different DNN layer types.

9. The DNN system of claim 1, wherein each of the multiple inputs is processed at a different DNN layer type.

10. The DNN system of claim 1, wherein an associated processing element for a queue processes with respect to a specific DNN layer.

11. The DNN system of claim 10, wherein the specific DNN layer is supported by different DNN networks to enable multiple use of the specific DNN layer.

12. A method for deep neural network (DNN) processing, the method comprising:
processing in parallel for multiple inputs:
writing a queue packet associated with each input to a queue, wherein each queue is mapped to one of a plurality of DNN layers in an inference pipeline; and
processing, by a processing element associated with each queue, the input based on a DNN processing profile determined from the queue packet.

13. The method of claim 12, wherein the queue packet identifies at least a DNN network identifier, a DNN layer identifier, a pointer to buffer for data, and previous/next DNN layer identifiers.

14. The method of claim 13, wherein the DNN layer identifier identifies a DNN layer type, which is used to determine a nature of computation to be performed and what kernels to launch.

15. The method of claim 13, wherein the DNN network identifier enables processing of multiple DNN workloads by designating which network to use.

16. The method of claim 13, wherein the previous/next DNN layer identifiers identify connected DNN layers.

17. The method of claim 13, wherein the queue packets include at least instructions on how to launch threads, provide a size of private memory allocation, provide a size of group memory allocation, provide a handle for an object in memory that includes an executable ISA image for a computation kernel, and control and synchronization information.

18. The method of claim 12, further comprising:
writing another queue packet to another queue based on the processed queue packet.

19. The method of claim 12, wherein the plurality of DNN layers are different DNN layer types.

20. The method of claim 12, wherein each of the multiple inputs is processed at a different DNN layer type.

21. The method of claim 12, wherein an associated processing element for a queue processes with respect to a specific DNN layer.

22. The method of claim 21, wherein the specific DNN layer is supported by different DNN networks to enable multiple use of the specific DNN layer.
